(19) United States
(12) Patent Application Publication
(10) Pub. No.: US 2026/0350663 A1
(43) Pub. Date: Nov. 5, 2026

(54) System and Method for Cycle Based Scoring, Grouping, Ranking, and Dynamic Placement for Messaging Based Commerce Using Hits, Cycle Hits, and Hits History

(71) Applicant: Dario Chang, Doral, FL (US)

(72) Inventor: Dario Chang, Doral, FL (US)

(21) Appl. No.: 19/719,350

(22) Filed: Jun. 25, 2026

(51) Int. Cl. G06Q 30/0283

(52) U.S. Cl. CPC G06Q 30/0283

(57) ABSTRACT

A computer-implemented system and method for ranking, promoting, and allocating commercial interactions inside a messaging-based commerce environment. Metadata-level interaction events are converted into hits that accumulate into cycles, with cycle termination triggering updates to a long-term Hits History. Merchants are grouped according to their Cycle Hits and Hits History values, ranked within groups, and rotated according to fairness rules. Pricing, settlement, and arbitration outcomes are dynamically adjusted based on cycle behavior and historical performance. The system supports privacy-preserving scoring using metadata only, on-device or federated computation, and cross-platform coordination across partner networks. Fraud-cycle detection identifies abnormal patterns and applies penalties affecting group placement, rotation, and pricing. The invention enables unified scoring, rotation, and settlement across messaging funnels, web funnels, and offline-to-online events while maintaining compatibility with the parent application's hit-based cycle model.

### CROSS-REFERENCE TO RELATED APPLICATIONS

This application is a Continuation-in-Part of U.S. patent application Ser. No. 10/605,894, filed Nov. 4, 2003, the entirety of which is incorporated herein by reference.

The present application does not introduce any new scoring primitives. All scoring, grouping, rotation, dynamic pricing, and cycle-termination mechanisms disclosed herein are direct embodiments of the Cycle Hits, Hits History, grouping, rotation, dynamic pricing, and machine-state transition primitives disclosed in the 2003 parent.

The modern embodiments described in this application—including but not limited to:
encrypted messaging funnels,
metadata-only scoring in privacy-preserving environments,
on-device scoring,
federated aggregation,
artificial-intelligence merchant agents,
cycle-based settlement and arbitration,
fraud-cycle suppression,
multi-agent orchestration, and
cross-engine exchange-group rotation—
   are implementations of the same primitives in contemporary environments and do not alter the underlying scoring logic disclosed in the 2003 parent.

### FIELD OF THE INVENTION

The present invention relates to systems and methods for cycle-based scoring, grouping, ranking, and dynamic placement of commercial entities, as originally disclosed in U.S. application Ser. No. 10/605,894 (filed Nov. 4, 2003). The invention applies these same primitives—Cycle Hits, Hits History, group-based segmentation, rotation fairness, dynamic pricing, and machine-state transitions—to modern messaging-based commerce environments, including but not limited to:
encrypted chat platforms, metadata-only interaction environments, mobile messaging applications, federated scoring architectures, on-device scoring systems, and AI-assisted merchant orchestration systems.

The invention further relates to privacy-preserving commercial scoring in environments where message content and personal identifiers are inaccessible, and where only metadata-level interaction events (such as timestamps, event types, event order, and payment completion signals) are available for scoring.

The invention also relates to cycle-based settlement, arbitration, fraud-cycle suppression, and partner-network rotation in messaging-based commerce ecosystems, where merchants compete for visibility, placement, and ranking inside chat-driven commercial funnels.

The invention extends the 2003 parent's primitives to support:
multistep messaging funnels (view→click→chat→message→quote→payment),
non-PII scoring,
distributed and federated aggregation,
AI-driven merchant decisioning,
cross-platform exchange-group rotation, and
dynamic placement inside messaging interfaces.

All such embodiments remain direct implementations of the scoring, grouping, rotation, and dynamic pricing primitives disclosed in the 2003 parent, adapted to contemporary messaging-based commerce environments without altering the underlying logic.

### BACKGROUND OF THE INVENTION

Online commerce has evolved from static, webpage-based interactions to dynamic, conversational environments. Modern messaging platforms—including WhatsApp, Messenger, Telegram, and WeChat—have become primary commercial surfaces where users initiate purchases, request quotes, negotiate terms, and complete payments inside chat threads rather than on traditional websites. These environments generate multistep behavioral sequences that cannot be scored using conventional click-based or identity-based advertising systems.

Messaging-based commerce introduces requirements that differ fundamentally from traditional web advertising. These environments require:
multistep conversion scoring across chat-based funnels, ranking and placement without feeds or webpages, privacy-preserving aggregation where message content is inaccessible, fairness rotation to prevent overexposure of dominant merchants, fraud-cycle suppression to detect abnormal or bot-like interaction patterns, cycle-based settlement and arbitration, and cross-engine partner-network rotation for merchants operating across multiple messaging platforms.

These requirements align directly with the primitives disclosed in the 2003 parent, which introduced Cycle Hits, Hits History, group-based segmentation, rotation fairness, dynamic pricing, and machine-state transitions.

Traditional bid-for-position and pay-per-click systems fail in messaging environments for several reasons:
1. They rely on identity-based tracking, which is incompatible with encrypted messaging platforms.
2. They assume webpage-based interactions, not chat-based multistep sequences.
3. They cannot compute Cycle Hits across messaging funnels.
4. They cannot enforce rotation fairness or group-based placement.
5. They cannot support partner-network exchange groups or cross-platform rotation.
6. They cannot compute cycle-based settlement, which is required when payments occur inside chat threads.

As a Result, Existing Systems Cannot Operate in Modern Messaging-commerce ecosystems.

The 2003 parent introduced Cycle Hits and Hits History as primitives for scoring multistep behavioral chains and grouping accounts by score. These primitives were originally applied to repeated interactions with advertisements or listings, but the underlying logic—accumulating hits into cycles and aggregating cycles into long-term history—directly supports the scoring of messaging-based commerce funnels.

The parent further discloses cycle-termination logic, in which an asset is unlisted after reaching a threshold and later relisted at a minimum entry fee. This logic applies directly to messaging funnels where sequences of view→click→chat→message→payment→repeat purchase form cycles. When a payment or merchant-defined cap is reached, the cycle terminates, and the merchant transitions into a new machine state (e.g., cooldown, relist), consistent with the parent's disclosures.

Messaging-based commerce introduces additional constraints that reinforce the need for the parent's primitives:
Encrypted environments, where message content cannot be accessed.
Lack of personal identifiers, requiring non-PII scoring.
On-device scoring, where interaction events are processed locally.
Federated aggregation, where multiple devices contribute partial scores.
AI-assisted merchant workflows, where automated agents adjust budgets, thresholds, and promotions.
Cycle-based settlement, where payment completion triggers settlement logic.
Fraud-cycle suppression, where abnormal hit patterns must be detected and penalized.

These constraints do not alter the underlying scoring logic; they simply require modern embodiments of the 2003 primitives.

Accordingly, there exists a need for a cycle-based scoring, grouping, ranking, and dynamic placement system that operates effectively in encrypted messaging environments, supports privacy-preserving aggregation, enables fair rotation, detects fraud cycles, and provides cycle-based settlement and arbitration. The present invention satisfies this need by extending the 2003 parent's primitives to contemporary messaging-based commerce while preserving the original scoring logic.

### SUMMARY OF THE INVENTION

The present invention provides a cycle-based scoring, grouping, ranking, and dynamic placement system for modern messaging-based commerce environments, implemented as a direct continuation of the Cycle Hits, Hits History, group-based segmentation, rotation fairness, and dynamic pricing primitives disclosed in U.S. application Ser. No. 10/605,894 (filed Nov. 4, 2003). The invention adapts these primitives to contemporary encrypted messaging platforms and mobile chat-driven commercial workflows without altering the underlying scoring logic.

The invention computes a Cycle Hits score by accumulating interaction events across a multistep messaging funnel, including viewing a merchant entry, initiating a chat, exchanging messages, receiving a quote, clicking a payment link, completing a payment, and repeating a purchase. Each event contributes a hit, and the sequence forms a cycle that terminates when a threshold is reached, consistent with the parent's cycle-termination model.

The invention further computes a Hits History score that aggregates prior cycles using time-weighted decay, lineage scoring, cumulative engagement history, or other parent-supported weighting mechanisms. Hits History provides long-term stability, supports dynamic pricing, and determines group assignment.

Merchants are segmented into groups based on Cycle Hits, Hits History, or combinations thereof. Grouping enables fair competition among merchants with similar performance, supports dynamic pricing, and provides the foundation for rotation-based placement, partner-network exchange groups, and waiting-list marketplace behavior, all of which are disclosed in the 2003 parent.

A ranking module computes placement scores using Cycle Hits, Hits History, group assignment, rotation rules, fraud-cycle adjustments, and payment-completion cycles. Ranking determines visibility, promotion weight, ordering in messaging directories, and settlement value.

A rotation and fairness module ensures equitable distribution of placement opportunities. Rotation rules may include time-based rotation, score-based rotation, partner-network rotation, cooldown states, and relisting states, consistent with the parent's machine-state transitions and rotation-group disclosures.

The invention includes a privacy-preserving aggregation module that computes Cycle Hits and Hits History without storing personal identifiers. Scoring may be performed on-device, with only aggregated values transmitted to the server, or via federated scoring, where multiple devices compute partial values and merge them into a unified group assignment. These embodiments extend the parent's non-identifying scoring model to encrypted messaging environments.

The invention further includes artificial-intelligence merchant agents that operate within the cycle-based scoring framework to adjust budgets, modify thresholds, prioritize chats, trigger promotions, escalate leads, manage disputes, and optimize rotation positions. These agents automate decisions supported by the parent's dynamic pricing and cycle-termination logic.

The invention detects fraud cycles, including spam bursts, bot-like sequences, abnormal traffic, and credit-score anomalies. When detected, the system may reduce Cycle Hits, apply negative Hits History adjustments, demote the merchant, or move the merchant into a penalty group, consistent with the parent's popularity, traffic, and credit-score weighting.

A settlement and arbitration module uses cycle-verified events to determine payment release, dispute resolution, arbitration outcomes, refund logic, and merchant penalties. Settlement is based on cycle completion, conversion ratios, Hits History stability, fraud-cycle suppression, and rotation-group position, extending the parent's dynamic pricing and cycle-termination logic to modern messaging-commerce workflows.

The invention also supports exchange-group rotation across partner networks, enabling merchants to be rotated across multiple messaging or commerce platforms using shared scoring, shared group assignment, and shared waiting lists. This is a direct extension of the parent's partner-network rotation and exchange-group disclosures.

Overall, the invention provides a unified, cycle-based scoring and ranking system for messaging-based commerce that preserves the 2003 parent's primitives while enabling modern embodiments such as encrypted chat scoring, on-device aggregation, federated scoring, AI-assisted workflows, fraud-cycle suppression, settlement, arbitration, and cross-platform exchange-group rotation.

### OVERVIEW

The present invention provides a unified framework for cycle-based scoring, grouping, ranking, and dynamic placement of merchants operating inside messaging-based commerce environments. The system directly extends the Cycle Hits, Hits History, group-based segmentation, rotation fairness, and dynamic pricing primitives disclosed in the 2003 parent, applying them to modern encrypted chat platforms and mobile messaging ecosystems without altering the underlying scoring logic.

The invention computes a Cycle Hits score for each merchant by accumulating interaction events across a multistep messaging funnel. Each event—such as viewing a merchant profile, clicking a message button, opening a chat thread, sending a message, receiving a reply, viewing a quote, clicking a payment link, or completing a payment—contributes a hit. These hits accumulate until a cycle threshold is reached, at which point the cycle terminates in accordance with the parent's cycle-termination model.

The invention also computes a Hits History score, which aggregates prior cycles using parent-supported mechanisms such as time-weighted decay, lineage scoring, cumulative engagement history, popularity weighting, traffic weighting, and credit-score weighting. Hits History provides long-term ranking stability and supports dynamic pricing.

Merchants are segmented into groups based on Cycle Hits, Hits History, or combinations thereof. Grouping enables fair competition among merchants with similar performance, supports dynamic pricing, and provides the foundation for rotation-based placement, partner-network exchange groups, and waiting-list marketplace behavior, all of which are disclosed in the 2003 parent.

A ranking module determines placement, promotion weight, and visibility level for each merchant based on Cycle Hits, Hits History, group assignment, rotation rules, fraud-cycle adjustments, and payment-completion cycles. Ranking determines ordering in messaging directories, chat-based discovery surfaces, and other messaging-commerce interfaces.

A rotation and fairness module ensures equitable distribution of placement opportunities. Rotation rules may include time-based rotation, score-based rotation, partner-network rotation, cooldown states, and relisting states, consistent with the parent's machine-state transitions and rotation-group disclosures.

The invention includes a privacy-preserving aggregation module that computes Cycle Hits and Hits History without storing personal identifiers. Scoring may be performed on-device, with only aggregated values transmitted to the server, or via federated scoring, where multiple devices compute partial values and merge them into a unified group assignment. These embodiments extend the parent's non-identifying scoring model to encrypted messaging environments.

The invention further includes artificial-intelligence merchant agents that operate within the cycle-based scoring framework to adjust budgets, modify thresholds, prioritize chats, trigger promotions, escalate leads, manage disputes, and optimize rotation positions. These agents automate decisions supported by the parent's dynamic pricing and cycle-termination logic.

The system detects fraud cycles, including spam bursts, bot-like sequences, abnormal traffic, and credit-score anomalies. When detected, the system may reduce Cycle Hits, apply negative Hits History adjustments, demote the merchant, or move the merchant into a penalty group, consistent with the parent's popularity, traffic, and credit-score weighting.

A settlement and arbitration module uses cycle-verified events to determine payment release, dispute resolution, arbitration outcomes, refund logic, and merchant penalties. Settlement is based on cycle completion, conversion ratios, Hits History stability, fraud-cycle suppression, and rotation-group position, extending the parent's dynamic pricing and cycle-termination logic to modern messaging-commerce workflows.

The invention also supports exchange-group rotation across partner networks, enabling merchants to be rotated across multiple messaging or commerce platforms using shared scoring, shared group assignment, and shared waiting lists. This is a direct extension of the parent's partner-network rotation and exchange-group disclosures.

Overall, the invention provides a comprehensive, cycle-based scoring and ranking system for messaging-based commerce that preserves the 2003 parent's primitives while enabling modern embodiments such as encrypted chat scoring, on-device aggregation, federated scoring, AI-assisted workflows, fraud-cycle suppression, settlement, arbitration, and cross-platform exchange-group rotation.

### BRIEF DESCRIPTION OF THE DRAWINGS

No drawings are required for understanding the invention. However, embodiments of the invention may be illustrated using conceptual diagrams, flowcharts, or state-transition representations. Any such figures, if provided, are intended solely to aid understanding and do not limit the scope of the invention.

### BRIEF SUMMARY OF THE INVENTION

The invention provides a cycle-based scoring, grouping, ranking, and dynamic placement system for messaging-based commerce environments. Interaction events occurring inside encrypted or metadata-only messaging funnels are converted into hits, accumulated into cycles, and aggregated into long-term Hits History values. These values determine group assignment, ranking, rotation, dynamic pricing, settlement, and arbitration. The invention operates without accessing message content or personal identifiers and supports on-device scoring, federated aggregation, AI-assisted merchant workflows, fraud-cycle suppression, and cross-platform exchange-group rotation. All mechanisms disclosed herein are direct embodiments of the Cycle Hits, Hits History, grouping, rotation, dynamic pricing, and machine-state transition primitives disclosed in U.S. application Ser. No. 10/605,894 (filed Nov. 4, 2003).

### DEFINITIONS

As used herein:

“Hit” means a metadata-level interaction event associated with a merchant, including but not limited to viewing a profile, opening a chat, sending a message, receiving a reply, viewing a quote, clicking a payment link, or completing a payment.

“Cycle Hit” means a hit that contributes to an accumulating sequence of events forming a cycle.

“Cycle” means a sequence of hits that terminates when a threshold is reached, including payment completion, merchant-defined caps, or cycle-velocity triggers.

“Hits History” means a long-term, time-weighted aggregate of completed cycles, used for grouping, ranking, rotation, and pricing.

“Group” means a set of merchants with similar Cycle Hits, Hits History, or performance characteristics, used for fair competition and rotation.

“Rotation” means the process of adjusting merchant placement within a group to ensure equitable exposure.

“Dynamic pricing” means adjusting merchant cost or settlement value based on Cycle Hits, Hits History, group assignment, or rotation position.

“Messaging-based commerce funnel” means a multistep sequence of interactions occurring inside a messaging environment.

“Metadata-only scoring” means scoring based solely on event types, timestamps, and ordering, without accessing message content or personal identifiers.

### DETAILED DESCRIPTION

The present invention extends the Cycle Hits and Hits History primitives disclosed in the 2003 parent to modern messaging-based commerce environments, including encrypted chat platforms, mobile messaging applications, and distributed scoring architectures. The core primitives remain unchanged: the system computes hits, aggregates them into cycles, and accumulates cycles into Hits History. These values determine grouping, ranking, rotation, dynamic pricing, settlement, and arbitration, exactly as described in the parent.

The invention adapts these primitives to environments where commercial interactions occur inside multistep messaging funnels, where message content is inaccessible, and where only metadata-level events (timestamps, event types, event order, payment completion signals) are available. These constraints do not alter the underlying scoring logic; they simply require modern embodiments of the parent's primitives.

The invention further supports on-device scoring, federated aggregation, AI-assisted merchant workflows, fraud-cycle suppression, and cross-platform exchange-group rotation, all of which operate within the same cycle-based scoring framework disclosed in the 2003 parent. These embodiments enable the system to function in encrypted messaging environments while preserving the parent's non-identifying scoring model.

The 2003 parent describes Cycle Hits and Hits History as the foundation of a dynamic marketplace in which accounts are grouped by score, rotated for fairness, and priced dynamically based on accumulated cycles. The parent further discloses cycle termination, machine-state transitions (listed, unlisted, cooldown, relist), waiting lists, partner-network rotation, popularity weighting, traffic weighting, and credit-score weighting.

These disclosures provide full written-description support for the present invention's:
messaging-based Cycle Hits sequences, time-weighted Hits History scoring, group-based segmentation of merchants, rotation-based placement inside messaging interfaces, dynamic pricing based on cycle thresholds, fraud-cycle suppression, cycle-based settlement and arbitration, on-device and federated scoring, and cross-platform exchange-group rotation.

The present invention therefore constitutes a direct continuation of the parent's primitives, applied to modern messaging-commerce environments without altering the underlying scoring logic.

### CYCLE HITS—Definition and Parent Support

A Cycle Hit is a unit of interaction representing a user action associated with a merchant or asset. In the 2003 parent, hits correspond to repeated interactions with advertisements or listings, and these hits accumulate into cycles that determine pricing, grouping, and rotation. The present invention applies this same primitive to messaging-based commerce sequences, where commercial interactions occur inside chat threads rather than on webpages.

In messaging environments, a Cycle Hit may correspond to any metadata-level interaction event, including but not limited to:
viewing a merchant profile or listing, clicking a “Message” or “Chat” button, opening a chat thread, sending a message, receiving a merchant reply, viewing a quote or catalog, clicking a payment link, completing a payment, or repeating a purchase.

Each of these events contributes a hit, and the sequence forms a Cycle Hits chain consistent with the parent's description of repeated hits forming cycles.

This adaptation does not introduce new primitives; it applies the parent's Cycle Hits model to modern messaging funnels where message content is inaccessible and only metadata events are available.

### CYCLE ACCUMULATION AND TERMINATION

Cycle Hits accumulate until a cycle threshold is reached. The 2003 parent describes this threshold as the point where:
“the advertiser reaches their top price or cap, the Ad is unlisted and later relisted.”

This same logic applies directly to messaging-based commerce funnels.

A cycle may terminate when:
a payment is completed, a merchant-defined cap is reached, a conversion event occurs, a cycle-velocity threshold is exceeded, or a fraud-cycle suppression trigger is activated.

Upon termination, the merchant transitions into a new machine state (e.g., cooldown, unlisted, relist), exactly as disclosed in the parent.

Cycle termination in messaging funnels is therefore a direct embodiment of the parent's cycle-termination logic, adapted to chat-based commercial sequences.

### METHODS OF COMPUTING CYCLE HITS

Cycle Hits may be computed using any of the parent-supported mechanisms for detecting repeated interactions, including:
periodicity detection, recurrence windows, surge-based reinforcement, multistep behavioral sequences, time-ordered event chains, cycle-velocity indicators, and metadata-only event classification.

These techniques are fully supported by the parent's disclosures of repeated hits, cycles, dynamic pricing, and score accumulation.

In messaging-based commerce, cycle hits may be computed:
on-device, where interaction events are processed locally and only aggregated values are transmitted; via federated scoring, where multiple devices compute partial Cycle Hits and merge them; or server-side, using aggregated metadata events.

All such embodiments remain consistent with the parent's non-identifying scoring model, which scores accounts based on hits rather than personal identifiers.

HITS HISTORY—Definition and Parent Support

Hits History is a time-weighted aggregate of Cycle Hits accumulated across multiple cycles. In the 2003 parent, Hits History represents a long-term performance score that determines group assignment, dynamic pricing, rotation behavior, and marketplace stability. The present invention applies this same primitive to messaging-based commerce funnels, where commercial interactions occur inside encrypted chat threads and are represented by metadata-level events.

Hits History may incorporate any of the parent-supported weighting mechanisms, including:
time-decayed weighting, lineage scoring, cumulative engagement history, popularity weighting, traffic weighting, and credit-score weighting.

These mechanisms allow the system to reflect both recent activity and long-term merchant performance, exactly as described in the parent.

In messaging-based commerce, Hits History aggregates cycles formed from sequences such as:
viewing a merchant profile, initiating a chat, exchanging messages, receiving a quote, clicking a payment link, completing a payment, and repeating a purchase.

Each completed sequence contributes a cycle, and each cycle contributes to Hits History. This adaptation does not introduce new primitives; it applies the parent's long-term scoring model to modern messaging funnels.

### HITS HISTORY—Computation and Use in Messaging Commerce

Hits History may be computed using any combination of the parent-supported techniques for aggregating cycles, including:
time-decayed merging, weighted averaging, lineage-based accumulation, cycle-velocity adjustments, fraud-cycle penalties, and cumulative engagement scoring.

In messaging-based commerce, Hits History may be computed:
on-device, where partial cycle summaries are generated locally;
via federated scoring, where multiple devices contribute partial Hits History values; or
server-side, using aggregated metadata events.

Hits History determines:
group assignment, ranking stability, dynamic pricing, promotion and demotion, rotation position, settlement value, and arbitration outcomes.

These uses are fully supported by the parent's disclosures of:
grouping advertisers by Hits History, pricing based on long-term score values,
rotation groups, waiting lists, partner-network rotation, and machine-state transitions.

Hits History therefore remains a direct continuation of the parent's long-term scoring primitive, adapted to encrypted messaging environments without altering the underlying logic.

### HITS HISTORY—Definition and Parent Support

Hits History is a time-weighted aggregate of Cycle Hits accumulated across multiple cycles. In the 2003 parent, Hits History represents a long-term performance score that determines group assignment, dynamic pricing, rotation behavior, and marketplace stability. The present invention applies this same primitive to messaging-based commerce funnels, where commercial interactions occur inside encrypted chat threads and are represented by metadata-level events.

Hits History may incorporate any of the parent-supported weighting mechanisms, including:
time-decayed weighting, lineage scoring, cumulative engagement history,
popularity weighting, traffic weighting, and credit-score weighting.

These mechanisms allow the system to reflect both recent activity and long-term merchant performance, exactly as described in the parent.

In messaging-based commerce, Hits History aggregates cycles formed from sequences such as:
viewing a merchant profile,
initiating a chat,
exchanging messages,
receiving a quote,
clicking a payment link,
completing a payment, and
repeating a purchase.

Each completed sequence contributes a cycle, and each cycle contributes to Hits History. This adaptation does not introduce new primitives; it applies the parent's long-term scoring model to modern messaging funnels.

### Grouping—Definition and Parent Support

The system segments merchants into groups based on Cycle Hits, Hits History, or combinations thereof. In the 2003 parent, grouping is a core primitive used to:
cluster advertisers with similar performance, ensure fair competition,
determine dynamic pricing, manage rotation behavior, and support waiting-list marketplace mechanisms.

The parent explicitly discloses grouping advertisers by:
similar Hits History, similar budget size, similar traffic, similar business type,
similar popularity, similar rotation history, and similar credit score.

These disclosures provide full written-description support for grouping merchants in messaging-based commerce environments using the same criteria.

In the present invention, grouping is applied to messaging-based commercial funnels, where merchants accumulate Cycle Hits and Hits History from metadata-level events such as viewing a profile, initiating a chat, exchanging messages, receiving a quote, clicking a payment link, and completing a payment. Merchants with similar performance across these funnels are placed into the same group.

This adaptation does not introduce new primitives; it applies the parent's grouping logic to modern messaging environments.

### GROUPING—Purpose and Function in Messaging Commerce

Grouping enables fair competition among merchants with similar performance characteristics. In messaging-based commerce, grouping serves several critical functions:
Dynamic pricing: Merchants in higher-performing groups may pay higher amounts or receive different placement outcomes, consistent with the parent's dynamic pricing model.
Rotation-based placement: Merchants within a group are rotated to ensure equitable exposure, preventing dominant merchants from monopolizing visibility.
Partner-network exchange groups: Groups may be shared across messaging platforms, enabling cross-platform rotation and shared scoring.
Waiting-list marketplace behavior: When a group is full, additional merchants may be placed on a waiting list until a rotation or cycle reset occurs.
Fraud-cycle suppression: Merchants exhibiting abnormal hit patterns may be moved into penalty groups with reduced placement.

These functions are direct embodiments of the parent's grouping, rotation, dynamic pricing, and waiting-list mechanisms.

### GROUP DYNAMICS—Movement Between Groups

Groups may be dynamic, with merchants moving between groups as their Cycle Hits, Hits History, or fraud-cycle indicators change. Movement between groups may occur when:
a merchant completes a cycle,
Hits History increases or decays,
cycle velocity changes,
fraud-cycle suppression is triggered,
payment-completion cycles occur, or
rotation-group rules require rebalancing.

These transitions correspond directly to the parent's disclosures of:
machine-state transitions (listed, unlisted, cooldown, relist),
dynamic pricing adjustments,
rotation-group rebalancing, and
waiting-list admission and removal.

Group movement in messaging-based commerce is therefore a direct continuation of the parent's grouping and rotation primitives, adapted to chat-based commercial sequences without altering the underlying logic.

### RANKING SCORE—Definition and Parent Support

A ranking score is computed for each merchant based on Cycle Hits, Hits History, group assignment, rotation rules, fraud-cycle adjustments, and payment-completion cycles. In the 2003 parent, ranking is determined by score values derived from repeated hits, accumulated cycles, and long-term performance. The present invention applies this same ranking logic to messaging-based commerce funnels, where commercial interactions occur inside encrypted chat threads and are represented by metadata-level events.

The ranking score may incorporate:
Cycle Hits accumulated during the current messaging funnel,
Hits History representing long-term performance,
group assignment based on score similarity,
rotation position within a group,
fraud-cycle penalties for abnormal hit patterns,
payment-completion Cycles Indicating Successful Conversions, and
cycle-velocity indicators reflecting the speed of user engagement.

These factors correspond directly to the parent's disclosures of:
ranking based on score values, grouping advertisers by performance, dynamic pricing based on accumulated cycles, rotation-group behavior, and
fraud-related score adjustments.

The ranking score in messaging-based commerce is therefore a direct continuation of the parent's ranking primitive, adapted to chat-based commercial sequences without altering the underlying logic.

### RANKING OUTCOMES—Placement and Visibility

The ranking score determines placement and visibility for each merchant within messaging-based commerce interfaces. Placement outcomes may include:
ordering in messaging directories,
ordering in chat-based discovery surfaces,
priority routing of new leads,
promotion weight for high-performing merchants,
visibility level inside chat-driven commerce modules, and
settlement value based on cycle-verified events.

These outcomes correspond directly to the parent's disclosures of:
ranking advertisers by score,
determining placement based on group assignment,
adjusting visibility based on dynamic pricing, and
promoting or demoting advertisers based on performance.

In messaging-based commerce, ranking determines which merchants appear:
at the top of chat-based directories,
in recommended merchant lists,
in “suggested businesses” modules,
in lead-routing queues, and
in payment-completion workflows.

This adaptation does not introduce new primitives; it applies the parent's ranking and placement logic to modern messaging environments.

### PARENT SUPPORT FOR RANKING AND PLACEMENT

The 2003 parent provides full written-description support for the present invention's ranking and placement mechanisms. The parent discloses:
ranking advertisers based on score values,
grouping advertisers by Hits History and performance,
dynamic pricing based on accumulated cycles,
rotation-group placement,
waiting-list admission and removal,
partner-network rotation, and
machine-state transitions affecting visibility.

These disclosures support the present invention's ranking of merchants in messaging-based commerce environments using Cycle Hits, Hits History, group assignment, rotation rules, fraud-cycle adjustments, and payment-completion cycles.

Ranking and placement in messaging-based commerce are therefore direct embodiments of the parent's ranking and placement primitives, adapted to encrypted chat environments without altering the underlying scoring logic.

### ROTATION AND FAIRNESS—Parent Support and Modern Embodiment

The system includes a rotation and fairness module that ensures equitable distribution of placement opportunities among merchants. In the 2003 parent, rotation groups are a core primitive used to:
prevent overexposure of high-performing advertisers,
ensure fair distribution of listing space,
balance marketplace visibility,
manage machine-state transitions (listed→pending unlist→unlisted→cooldown→relist), and
support partner-network rotation across multiple platforms.

The present invention applies these same rotation primitives to messaging-based commerce environments, where merchants compete for visibility inside chat-driven discovery surfaces, messaging directories, and lead-routing queues.

Rotation ensures that merchants with similar Cycle Hits and Hits History receive fair exposure, even when operating in encrypted messaging environments where message content is inaccessible and only metadata-level events are available.

This adaptation does not introduce new primitives; it directly implements the parent's rotation-group logic in modern messaging funnels.

### ROTATION RULES—Messaging-Based Implementation

Rotation rules may include any of the parent-supported mechanisms for distributing visibility among merchants, including:
time-based rotation, score-based rotation, partner-network rotation, cooldown states, relisting states, cycle-velocity adjustments, and fraud-cycle suppression adjustments.

In messaging-based commerce, rotation may determine:
which merchant appears first in a messaging directory,
which merchant receives the next inbound lead,
which merchant is prioritized in a chat-based discovery module,
which merchant is temporarily unlisted after reaching a cycle threshold, and
when a merchant is relisted after cooldown.

These rotation behaviors correspond directly to the parent's disclosures of:
rotation groups,
fairness placement,
machine-state transitions,
partner-network rotation, and
dynamic rebalancing of advertiser visibility.

Rotation in messaging-based commerce is therefore a direct continuation of the parent's rotation primitives.

### MACHINE-STATE TRANSITIONS—Parent Mapping

The 2003 parent discloses machine-state transitions including:
listed,
pending unlist,
unlisted,
cooldown, and relist.

These states govern when an advertiser is visible, when they are temporarily removed, and when they may re-enter the marketplace.

The present invention applies these same machine-state transitions to messaging-based commerce funnels, where a merchant may:
be listed in a messaging directory,
enter pending unlist when approaching a cycle threshold,
become unlisted after completing a payment or reaching a cap,
enter cooldown to prevent overexposure, and
relist after a cycle reset or rotation event.

These transitions are triggered by:
Cycle Hits accumulation,
Hits History changes,
payment-completion cycles,
fraud-cycle suppression,
rotation-group rules, and
partner-network exchange events.

Machine-state transitions in messaging-based commerce are therefore direct embodiments of the parent's rotation and fairness mechanisms, adapted to encrypted chat environments without altering the underlying logic.

### DYNAMIC PRICING—Definition and Parent Support

Dynamic pricing is computed based on Cycle Hits, Hits History, group assignment, rotation position, popularity, traffic, and credit-score weighting, exactly as disclosed in the 2003 parent. In the parent, dynamic pricing increases as an advertiser accumulates hits and approaches a cycle threshold, eventually triggering cycle termination, unlisting, and later relisting at a minimum entry fee.

The present invention applies this same dynamic pricing model to messaging-based commerce funnels, where merchants accumulate Cycle Hits from metadata-level events such as:
viewing a merchant profile,
initiating a chat,
exchanging messages,
receiving a quote,
clicking a payment link, and
completing a payment.

As Cycle Hits accumulate, the merchant's dynamic price increases until a cycle-termination threshold is reached, at which point the merchant may be:
temporarily unlisted,
placed into cooldown,
rotated out of the active group, or
relisted after a reset.

This is a direct embodiment of the parent's dynamic pricing and cycle-termination logic, adapted to encrypted messaging environments without altering the underlying scoring primitive.

### DYNAMIC PRICING—Messaging-Based Implementation

In messaging-based commerce, dynamic pricing may be computed using any combination of the parent-supported mechanisms, including:
Hits History weighting,
cycle-velocity adjustments,
fraud-cycle suppression penalties,
rotation-group position,
group-based pricing tiers, and
payment-completion cycles.

Dynamic pricing may determine:
the cost of receiving new leads,
the cost of appearing in messaging directories,
the cost of promotion or priority placement,
the cost of re-entry after cooldown, and
the cost of cross-platform rotation in partner networks.

These pricing outcomes correspond directly to the parent's disclosures of:
pricing based on accumulated hits,
pricing based on Hits History,
pricing based on group assignment,
pricing adjustments triggered by cycle termination, and
pricing changes associated with rotation and relisting.

Dynamic pricing in messaging-based commerce is therefore a direct continuation of the parent's dynamic pricing primitive.

### DYNAMIC PRICING—Parent Mapping and Modern Extensions

The 2003 parent describes dynamic pricing as a function of:
Hits History,
cycle termination,
group assignment,
popularity,
traffic, and
credit score.

These disclosures provide full written-description support for the present invention's dynamic pricing mechanisms in messaging-based commerce, including:
pricing based on Cycle Hits accumulated in chat funnels,
pricing based on long-term Hits History stability,
pricing based on fraud-cycle suppression,
pricing based on payment-completion cycles,
pricing based on rotation-group position, and
pricing based on partner-network exchange-group participation.

The present invention therefore extends the parent's dynamic pricing model to encrypted messaging environments while preserving the underlying scoring logic.

### WAITING LISTS—Parent Support and Modern Embodiment

The system includes a waiting-list marketplace mechanism that manages merchant admission into groups, rotation pools, and placement tiers. In the 2003 parent, waiting lists are explicitly disclosed as a mechanism for:
managing advertiser admission when a group is full,
enabling bidding among search engines or partner networks,
controlling marketplace congestion,
enforcing fairness, and
sequencing entry based on score, budget, or rotation history.

The present invention applies these same waiting-list primitives to messaging-based commerce environments, where merchants may need to wait for:
entry into a high-performing group,
access to a premium rotation tier,
visibility in a messaging directory,
participation in a partner-network exchange group, or
re-entry after cooldown or cycle termination.

Waiting lists in messaging-based commerce are therefore a direct continuation of the parent's waiting-list marketplace model, adapted to chat-based commercial sequences without altering the underlying logic.

### WAITING LISTS—Messaging-Based Implementation

In messaging-based commerce, waiting lists may be used to:
queue merchants for admission into a group when capacity is reached,
queue merchants for rotation when a cycle threshold triggers unlisting,
queue merchants for cross-platform exchange-group rotation,
queue merchants for premium placement in messaging directories,
queue merchants for lead-routing priority, and
queue merchants for re-entry after fraud-cycle suppression.

Waiting-list position may be determined by:
Hits History,
Cycle Hits,
group assignment,
rotation history,
fraud-cycle penalties,
payment-completion cycles, or
dynamic pricing thresholds.

These mechanisms correspond directly to the parent's disclosures of:
waiting lists for advertiser admission,
bidding among search engines,
group-based admission control,
rotation-based sequencing, and
dynamic pricing tied to marketplace congestion.

Waiting lists in messaging-based commerce therefore remain a direct embodiment of the parent's waiting-list marketplace primitive, extended to encrypted chat environments without altering the underlying scoring logic.

### PARTNER NETWORK EXCHANGE GROUPS—Parent Support and Modern Embodiment

The system includes Partner Network Exchange Groups, which allow merchants to be rotated, ranked, grouped, and priced across multiple platforms or partner networks. In the 2003 parent, partner-network exchange is explicitly disclosed as a mechanism for:
distributing advertisers across multiple search engines,
enabling bidding among partner networks,
sharing group assignments across platforms,
coordinating rotation behavior across networks, and
enforcing fairness and marketplace balance at a multi-platform level.

The present invention applies these same primitives to messaging-based commerce ecosystems, where merchants may operate across:
WhatsApp,
Facebook Messenger,
Instagram Direct,
Telegram,
WeChat,
or any other messaging-based commercial interface.

Partner Network Exchange Groups allow these platforms to share:
Cycle Hits,
Hits History,
group assignment,
rotation position,
waiting-list position, and
dynamic pricing tiers.

This ensures consistent merchant treatment across platforms and prevents any single platform from monopolizing merchant visibility.

This adaptation does not introduce new primitives; it directly implements the parent's partner-network exchange model in modern messaging environments.

### CROSS-PLATFORM ROTATION AND GROUP SHARING

Partner Network Exchange Groups enable cross-platform rotation, where merchants may be:
rotated from one messaging platform to another,
promoted or demoted across platforms based on shared scoring,
placed into shared waiting lists,
assigned to shared rotation groups, or
priced dynamically based on cross-platform performance.

Cross-platform rotation may occur when:
a merchant completes a cycle on one platform,
Hits History changes significantly,
fraud-cycle suppression is triggered,
a partner network requests additional merchants, or
a rotation-group rebalancing event occurs.

These behaviors correspond directly to the parent's disclosures of:
partner-network bidding,
cross-engine rotation,
shared group assignment,
shared waiting lists, and
dynamic rebalancing across networks.

In messaging-based commerce, cross-platform rotation ensures that merchants receive fair exposure across all partner networks, consistent with the parent's fairness and rotation principles.

### CROSS-PLATFORM SETTLEMENT AND ARBITRATION

Partner Network Exchange Groups also support cross-platform settlement and arbitration, where:
cycle-verified events from one platform may trigger settlement on another,
disputes may be resolved using shared hits history and fraud-cycle indicators,
arbitration outcomes may depend on cross-platform rotation history, and
penalties may be applied across all partner networks.

These mechanisms are fully supported by the parent's disclosures of:
dynamic pricing based on accumulated cycles,
credit-score weighting,
fraud-related score adjustments,
rotation-group penalties, and
partner-network coordination.

Cross-platform settlement and arbitration in messaging-based commerce are therefore direct embodiments of the parent's partner-network exchange model, extended to encrypted chat environments without altering the underlying scoring logic.

### FRAUD-CYCLE DETECTION—Parent Support and Modern Embodiment

The system includes a fraud-cycle detection module that identifies abnormal, artificial, or non-human interaction patterns within messaging-based commerce funnels. In the 2003 parent, fraud-related adjustments are explicitly supported through:
popularity weighting,
traffic weighting,
credit-score weighting,
negative score adjustments, and
penalty-group assignment.

These mechanisms allow the system to detect and penalize advertisers exhibiting suspicious or non-credible behavior.

The present invention applies these same fraud-related primitives to messaging-based commerce, where fraud may manifest as:
rapid, repeated chat initiations,
bot-generated message sequences,
artificial payment-link clicks,
abnormal cycle-velocity spikes,
coordinated manipulation of Cycle Hits,
synthetic lead generation, or
cross-platform abuse patterns.

Fraud-cycle detection in messaging-based commerce is therefore a direct continuation of the parent's fraud-related scoring model, adapted to encrypted chat environments without altering the underlying logic.

### FRAUD-CYCLE SUPPRESSION—Messaging-Based Implementation

When a fraud cycle is detected, the system may apply any of the parent-supported penalty mechanisms, including:
Cycle Hits reduction,
Hits History decay,
demotion to a lower group,
placement in a penalty group,
temporary unlisting,
cooldown state activation,
rotation-group penalties, or
dynamic pricing increases.

In messaging-based commerce, fraud-cycle suppression may be triggered by:
abnormal message-event frequency,
repeated chat initiations without meaningful engagement,
bot-like message patterns,
payment-link click anomalies,
cross-platform manipulation attempts, or
coordinated artificial traffic.

These suppression mechanisms correspond directly to the parent's disclosures of:
negative score adjustments,
credit-score penalties,
popularity and traffic weighting,
rotation-group demotion, and
machine-state transitions.

Fraud-cycle suppression in messaging-based commerce is therefore a direct embodiment of the parent's fraud-related scoring primitives.

### FRAUD-CYCLE ARBITRATION AND CROSS-PLATFORM ENFORCEMENT

The system may also include fraud-cycle arbitration, where disputes related to fraud detection are resolved using:
Cycle Hits history,
long-term Hits History stability,
rotation-group behavior,
cross-platform fraud indicators, and
partner-network exchange-group data.

Arbitration outcomes may include:
reinstatement of cycle hits,
confirmation of penalties,
cross-platform enforcement of penalties,
adjustment of dynamic pricing, or
modification of group assignment.

These arbitration mechanisms are fully supported by the parent's disclosures of:
credit-score weighting,
fraud-related score adjustments,
partner-network coordination,
dynamic pricing tied to credibility, and
machine-state transitions.

Fraud-cycle arbitration and cross-platform enforcement in messaging-based commerce are therefore direct continuations of the parent's fraud-related primitives, extended to encrypted chat environments without altering the underlying scoring logic.

### PRIVACY-PRESERVING SCORING—Parent Support and Modern Embodiment

The system includes a privacy-preserving scoring module that computes Cycle Hits, Hits History, group assignment, ranking, rotation, and dynamic pricing without accessing message content or personal identifiers. In the 2003 parent, the scoring model is inherently non-identifying, relying exclusively on:
hits,
cycles,
accumulated score values,
popularity weighting,
traffic weighting, and
credit-score weighting.

The parent does not require personal identifiers or message content to compute scores.

This provides full written-description support for the present invention's privacy-preserving scoring mechanisms.

The present invention applies the parent's non-identifying scoring model to encrypted messaging environments, where only metadata-level events are available, such as:
timestamps,
event types,
event order,
chat initiation signals,
message-exchange counts,
quote-view events,
payment-link clicks, and
payment-completion signals.

These metadata events are sufficient to compute Cycle Hits and Hits History using the parent's primitives.

This adaptation does not introduce new scoring primitives; it directly implements the parent's non-identifying scoring model in modern encrypted messaging ecosystems.

### ON-DEVICE AND FEDERATED SCORING

The system may compute Cycle Hits and Hits History using on-device scoring, federated scoring, or server-side aggregation, depending on the privacy requirements of the messaging platform.

### On-Device Scoring

Interaction events are processed locally on the user's device, and only aggregated score values (e.g., Cycle Hits increments or partial Hits History updates) are transmitted to the server. This preserves privacy while maintaining full compatibility with the parent's scoring model.

### Federated Scoring

Multiple devices compute partial Cycle Hits or partial Hits History values and merge them into a unified score. Federated scoring supports:
cross-device consistency,
privacy-preserving aggregation,
distributed scoring architectures, and encrypted environments where raw events cannot leave the device.

### Server-Side Aggregation

When permitted, metadata-level events may be aggregated server-side to compute Cycle Hits and Hits History.

All three embodiments remain fully consistent with the parent's non-identifying, hit-based scoring model.

### PRIVACY-PRESERVING GROUPING, RANKING, AND ROTATION

Because Cycle Hits and Hits History can be computed using metadata alone, the system can perform:
grouping,
ranking,
rotation,
dynamic pricing,
waiting-list admission,
partner-network exchange, and
fraud-cycle suppression
   without accessing message content or personal identifiers.

This is fully supported by the 2003 parent, which:
never requires message content,
never requires personal identifiers,
defines scoring purely in terms of hits, cycles, and accumulated score values,
defines grouping based on score similarity,
defines rotation based on fairness and cycle thresholds, and
defines dynamic pricing based on accumulated cycles.

Thus, privacy-preserving scoring in messaging-based commerce is a direct continuation of the parent's non-identifying scoring model, extended to encrypted chat environments without altering the underlying logic.

### AI-ASSISTED MERCHANT AGENTS—Parent Support and Modern Embodiment

The system includes AI-assisted merchant agents that operate within the cycle-based scoring framework to automate merchant decision-making. In the 2003 parent, automated decisioning is supported through:
dynamic pricing adjustments based on score,
automatic unlisting and relisting based on cycle termination,
rotation-group transitions,
credit-score weighting,
popularity and traffic weighting, and
partner-network bidding and coordination.

These mechanisms provide full written-description support for automated systems that modify merchant behavior based on Cycle Hits, Hits History, group assignment, rotation position, and fraud-cycle indicators.

The present invention applies these primitives to AI-assisted merchant agents operating in messaging-based commerce environments. These agents may:
adjust budgets,
modify thresholds,
prioritize leads,
escalate conversations,
trigger promotions,
manage disputes,
optimize rotation position, and
coordinate cross-platform behavior.

AI-assisted merchant agents therefore constitute a direct continuation of the parent's automated decisioning model, extended to encrypted messaging ecosystems without altering the underlying scoring logic.

### AI-ASSISTED WORKFLOWS—Messaging-Based Implementation

AI-assisted merchant agents may perform any of the following tasks, each of which is grounded in the parent's scoring, grouping, rotation, and pricing primitives:

### Lead Prioritization

Prioritize inbound chats based on Cycle Hits, Hits History, and conversion likelihood.

### Budget Optimization

Adjust merchant budgets based on dynamic pricing, cycle thresholds, and rotation position.

### Cycle-Aware Messaging

Modify merchant responses or timing based on cycle velocity and fraud-cycle indicators.

### Promotion Triggering

Trigger promotions when Cycle Hits approach a threshold or when Hits History decays.

### Cooldown and Relisting Management

Automatically manage machine-state transitions (listed→cooldown→relist) based on cycle termination.

### Cross-Platform Coordination

Adjust merchant behavior across partner networks using shared group assignment and rotation data.

### Dispute Handling and Arbitration Preparation

Prepare evidence for settlement or arbitration using cycle-verified events and fraud-cycle indicators.

These workflows correspond directly to the parent's disclosures of:
dynamic pricing,
cycle termination,
rotation-group behavior,
waiting-list sequencing,
partner-network coordination, and
fraud-related score adjustments.

Thus, AI-assisted workflows in messaging-based commerce are direct embodiments of the parent's automated decisioning logic.

### AI-ASSISTED SETTLEMENT, ARBITRATION, AND FRAUD MANAGEMENT

AI-assisted merchant agents may also support settlement, arbitration, and fraud-cycle management, using:
Cycle Hits sequences,
long-term Hits History stability,
rotation-group transitions,
cross-platform fraud indicators,
payment-completion cycles, and
partner-network exchange-group data.

Agents may:
prepare settlement packets,
recommend arbitration outcomes,
detect fraud-cycle anomalies,
apply penalties or request reinstatement,
coordinate cross-platform enforcement, and
adjust dynamic pricing based on arbitration results.

These capabilities are fully supported by the parent's disclosures of:
credit-score weighting,
fraud-related score adjustments,
dynamic pricing tied to credibility,
partner-network coordination, and
machine-state Transitions.

AI-assisted settlement and arbitration in messaging-based commerce are therefore direct continuations of the parent's automated decisioning primitives, extended to encrypted chat environments without altering the underlying scoring logic.

### SETTLEMENT—Parent Support and Modern Embodiment

The system includes a cycle-based settlement module that determines when payments, credits, or fees should be released, withheld, adjusted, or reversed. In the 2003 parent, settlement is supported through:
cycle termination,
dynamic pricing tied to accumulated cycles,
credit-score weighting,
popularity and traffic weighting,
fraud-related score adjustments, and
partner-network coordination.

These mechanisms provide full written-description support for settlement logic that depends on Cycle Hits, Hits History, group assignment, fraud-cycle indicators, and rotation-group behavior.

The present invention applies these primitives to messaging-based commerce, where settlement may be triggered by:
completion of a payment inside a chat funnel,
reaching a cycle threshold,
confirmation of a conversion event,
fraud-cycle suppression,
cross-platform rotation events, or
arbitration outcomes.

Settlement in messaging-based commerce is therefore a direct continuation of the parent's cycle-based pricing and credibility-weighted settlement model, adapted to encrypted chat environments without altering the underlying logic.

### ARBITRATION—Messaging-Based Implementation

The system includes an arbitration module that resolves disputes between merchants, customers, or partner networks using cycle-verified evidence. Arbitration may rely on:
Cycle Hits sequences,
long-term Hits History stability,
rotation-group transitions,
fraud-cycle indicators,
payment-completion cycles,
cross-platform scoring data, and
partner-network exchange-group records.

Arbitration outcomes may include:
confirmation of settlement,
reversal of settlement,
partial settlement,
reinstatement of Cycle Hits,
modification of Hits History,
group reassignment,
rotation-group penalties, or
dynamic pricing adjustments.

These arbitration mechanisms correspond directly to the parent's disclosures of:
credit-score weighting,
fraud-related score adjustments,
dynamic pricing tied to credibility,
partner-network coordination, and
machine-state transitions affecting visibility and pricing.

Arbitration in messaging-based commerce is therefore a direct embodiment of the parent's dispute-resolution primitives.

### CROSS-PLATFORM SETTLEMENT AND ARBITRATION

The system may also support cross-platform settlement and arbitration through Partner Network Exchange Groups. In this embodiment:
a cycle completed on one platform may trigger settlement on another,
fraud-cycle indicators may be shared across networks,
arbitration outcomes may apply across all partner platforms,
dynamic pricing may be adjusted based on cross-platform performance, and
penalties may be enforced globally across the exchange group.

These mechanisms are fully supported by the parent's disclosures of:
partner-network bidding,
cross-engine rotation,
shared group assignment,
shared waiting lists,
dynamic pricing tied to accumulated cycles, and
fraud-related score adjustments.

Cross-platform settlement and arbitration in messaging-based commerce are therefore direct continuations of the parent's partner-network coordination model, extended to encrypted chat environments without altering the underlying scoring logic.

### CROSS-PLATFORM COORDINATION—Parent Support and Modern Embodiment

The system includes a cross-platform coordination module that synchronizes Cycle Hits, Hits History, group assignment, rotation behavior, dynamic pricing, fraud-cycle suppression, and settlement logic across multiple messaging-based commerce platforms. In the 2003 parent, cross-platform coordination is explicitly supported through:
partner-network bidding,
shared group assignment,
cross-engine rotation,
waiting-list exchange,
dynamic pricing tied to multi-network performance, and
coordinated machine-state transitions.

These disclosures provide full written-description support for a modern architecture in which multiple messaging platforms—such as WhatsApp, Facebook Messenger, Instagram Direct, Telegram, or any other partner network—share scoring and rotation data.

The present invention applies these primitives to encrypted messaging ecosystems, where each platform may maintain its own metadata-level event stream, but all platforms share:
aggregated Cycle Hits,
aggregated Hits History,
group assignment,
rotation position,
waiting-list position,
fraud-cycle indicators, and
settlement and arbitration outcomes.

This ensures consistent merchant treatment across all partner networks and prevents any single platform from monopolizing visibility or manipulating scoring.

Cross-platform coordination in messaging-based commerce is therefore a direct continuation of the parent's partner-network coordination model, extended to encrypted chat environments without altering the underlying scoring logic.

### SHARED SCORING AND ROTATION ACROSS NETWORKS

Cross-platform coordination enables shared scoring and rotation, where merchants may be:
ranked using a unified cross-platform score,
grouped using shared Cycle Hits and Hits History,
rotated across multiple messaging surfaces,
placed into shared waiting lists,
promoted or demoted across networks,
penalized across all platforms for fraud-cycle behavior, and
dynamically priced based on cross-platform performance.

Shared scoring may be implemented using:
Federated Scoring,
on-device partial scoring,
server-side aggregation, or
Partner-network Exchange-group Merging.

Rotation may be coordinated so that:
a merchant unlisted on one platform may be rotated into another,
a merchant in cooldown on one platform may remain visible on another,
cycle termination on one platform may trigger relisting on another, and
partner networks may request merchants from each other based on demand.

These behaviors correspond directly to the parent's disclosures of:
cross-engine rotation,
partner-network bidding,
shared group assignment,
waiting-list exchange, and
dynamic rebalancing across networks.

Thus, shared scoring and rotation across messaging platforms are direct embodiments of the parent's multi-network coordination primitives.

### CROSS-PLATFORM MACHINE-STATE SYNCHRONIZATION

The system may synchronize machine-state transitions across partner networks. In the 2003 parent, machine-state transitions (listed, pending unlist, unlisted, cooldown, relist) govern visibility, pricing, and rotation. The present invention extends these transitions across multiple messaging platforms.

### Cross-platform Machine-state Synchronization May Include:

Unified Listing State
   A merchant listed on one platform may be listed on all platforms.
Unified Pending-Unlist State
   Approaching a cycle threshold on one platform may trigger pending-unlist across all platforms.
Unified Unlisted State
   Completing a cycle on one platform may unlist the merchant across all platforms.
Unified Cooldown State
   Cooldown may apply globally across partner networks.
Unified Relisting State
   Relisting may occur simultaneously across all platforms after a cycle reset.

Synchronization may also incorporate:
fraud-cycle suppression,
arbitration outcomes,
dynamic pricing adjustments,
partner-network demand signals, and
cross-platform rotation-group rebalancing.

These mechanisms are fully supported by the parent's disclosures of:
machine-state transitions,
partner-network coordination,
dynamic pricing tied to accumulated cycles,
fraud-related score adjustments, and
cross-engine rotation.

Cross-platform machine-state synchronization in messaging-based commerce is therefore a direct continuation of the parent's multi-network coordination model, extended to encrypted chat environments without altering the underlying scoring logic.

### SYSTEM ARCHITECTURE—Parent Support and High-Level Structure

The system architecture comprises multiple coordinated modules that implement the cycle-based scoring, grouping, ranking, rotation, pricing, settlement, arbitration, and partner-network exchange primitives disclosed in the 2003 parent. The architecture is designed to operate in encrypted, metadata-only messaging environments, where message content is inaccessible and only event-level signals are available.

### The Architecture Includes:

a Scoring Engine for computing Cycle Hits and Hits History,
a Grouping Engine for segmenting merchants into performance-based groups,
a Ranking Engine for determining placement and visibility,
a Rotation Engine for enforcing fairness and machine-state transitions,
a Dynamic Pricing Engine for adjusting costs based on cycles and long-term performance,
a Fraud-Cycle Detection Engine for identifying abnormal patterns,
a Settlement and Arbitration Engine for resolving disputes and releasing payments, and
a Partner-Network Exchange Engine for cross-platform coordination.

Each module corresponds directly to a primitive disclosed in the 2003 parent, ensuring full written-description support and continuity of the original scoring model.

The architecture may be implemented:
on a single platform,
across multiple messaging platforms,
across partner networks,
using federated scoring,
using on-device partial scoring, or
using server-side aggregation.

This modular design allows the system to operate in modern messaging ecosystems while preserving the parent's non-identifying, hit-based scoring logic.

### CORE MODULES—Detailed Description

The system architecture includes the following core modules, each of which is a direct embodiment of a primitive disclosed in the 2003 parent:

### (1) Scoring Engine

Computes Cycle Hits and Hits History using metadata-level events. Implements:
periodicity detection,
recurrence windows,
cycle-velocity indicators,
time-decayed weighting,
lineage scoring, and
fraud-cycle adjustments.

### (2) Grouping Engine

Segments merchants into groups based on:
Cycle Hits,
Hits History,
popularity,
traffic,
credit score,
rotation history, and
budget size.

Fully supported by the parent's grouping disclosures.

### (3) Ranking Engine

Determines placement and visibility using:
group assignment,
rotation position,
fraud-cycle penalties,
payment-completion cycles, and
long-term Hits History stability.

### (4) Rotation Engine

Implements:
time-based rotation,
score-based rotation,
cooldown and relisting,
machine-state transitions, and
partner-network rotation.

Directly supported by the parent's rotation-group model.

### (5) Dynamic Pricing Engine

Adjusts pricing based on:
accumulated cycles,
Hits History,
fraud-cycle suppression,
rotation position, and
partner-network demand.

### (6) Fraud-Cycle Detection Engine

Identifies:
bot-like sequences,
abnormal cycle velocity,
synthetic traffic,
artificial payment-link clicks, and
cross-platform manipulation.

Applies penalties consistent with the parent's credit-score and popularity-weighting disclosures.

### (7) Settlement and Arbitration Engine

Uses cycle-verified events to determine:
payment release,
dispute outcomes,
penalties,
reinstatement, and
cross-platform enforcement.

### (8) Partner-Network Exchange Engine

Coordinates:
shared scoring,
shared group assignment,
cross-platform rotation,
waiting-list exchange, and
cross-platform settlement.

This module is a direct continuation of the parent's partner-network bidding and exchange-group model.

### DISTRIBUTED AND FEDERATED ARCHITECTURE

The system may operate in a distributed or federated architecture, where scoring and rotation logic are shared across multiple devices or platforms. This embodiment is particularly suited to encrypted messaging environments.

### Distributed Architecture

Each platform maintains:
local Cycle Hits,
local Hits History,
local rotation state, and
local fraud-cycle indicators.

Platforms exchange aggregated values through Partner Network Exchange Groups.

### Federated Architecture

Devices compute partial scores locally and transmit only aggregated values. The federated model supports:
privacy-preserving scoring,
cross-device consistency,
multi-platform coordination, and
encrypted environments where raw events cannot be shared.

### Hybrid Architecture

Combines:
on-device scoring,
server-side aggregation, and
partner-network synchronization.

All distributed and federated embodiments remain fully consistent with the parent's non-identifying scoring model, which relies exclusively on hits, cycles, and accumulated score values.

### EVENT PROCESSING PIPELINE—Parent Support and Modern Embodiment

The system includes an event-processing pipeline that ingests metadata-level interaction events from messaging-based commerce funnels and converts them into Cycle Hits, cycle-termination signals, and Hits History updates. In the 2003 parent, event processing is supported through:
repeated hits detection,
cycle accumulation,
cycle termination,
dynamic pricing adjustments,
rotation-group transitions, and
partner-network coordination.

The present invention applies these primitives to encrypted messaging environments, where message content is inaccessible and only metadata-level events are available. The event-processing pipeline may include:

### (1) Event Ingestion Layer

Receives metadata-level events such as:
chat initiation,
message-exchange counts,
quote-view events,
payment-link clicks,
payment-completion signals,
timestamps,
event ordering, and
cross-platform routing events.

### (2) Event Normalization Layer

Normalizes events into a unified schema, including:
event type,
event timestamp,
event sequence number,
merchant identifier,
funnel identifier, and
platform identifier.

### (3) Event Classification Layer

Classifies events into categories such as:
hit events,
cycle-progress events,
cycle-termination events,
fraud-cycle indicators,
rotation-trigger events, and
settlement-trigger events.

### (4) Scoring Layer

Converts classified events into:
Cycle Hits increments,
cycle-velocity indicators,
Hits History updates,
fraud-cycle adjustments, and
group-assignment changes.

### (5) Output Layer

Emits:
updated scores,
updated group assignments,
rotation-state changes,
pricing adjustments,
settlement triggers, and
partner-network exchange signals.

This pipeline is a direct continuation of the parent's hit-based scoring and cycle-processing model, adapted to modern messaging ecosystems without altering the underlying logic.

### DATA FLOWS AND MODULE INTERACTIONS

The system architecture supports modular data flows between the scoring, grouping, ranking, rotation, pricing, fraud-cycle, settlement, and partner-network exchange engines. These data flows correspond directly to the parent's disclosures of:
score accumulation,
cycle termination,
dynamic pricing,
rotation-group behavior,
waiting-list sequencing,
partner-network bidding, and
fraud-related score adjustments.

### (1) Scoring→Grouping

Cycle Hits and Hits History updates flow into the Grouping Engine, which assigns merchants to groups based on performance.

### (2) Grouping→Ranking

Group assignment flows into the Ranking Engine, which determines placement and visibility.

### (3) Ranking→Rotation

Ranking outcomes flow into the Rotation Engine, which enforces fairness and machine-state transitions.

### (4) Rotation→Pricing

Rotation position and cycle-termination events flow into the Dynamic Pricing Engine.

### (5) Pricing→Settlement

Pricing thresholds and cycle-termination events flow into the Settlement Engine.

### (6) Fraud-Cycle Engine→All Modules

Fraud-cycle indicators may:
reduce scores,
demote groups,
alter ranking,
trigger cooldown,
increase pricing, or
block settlement.

### (7) Partner-Network Exchange Engine→All Modules

Cross-platform signals may:
update scores,
update groups,
update rotation position,
update pricing tiers,
update waiting-list position, or
enforce arbitration outcomes.

These data flows ensure that all modules operate coherently across single-platform and multi-platform environments.

### IMPLEMENTATION MODES—CLOUD, ON-DEVICE, FEDERATED, HYBRID

The system may be implemented in multiple modes, each fully supported by the parent's non-identifying scoring model.

### (1) Cloud-Based Implementation

All event processing, scoring, grouping, ranking, rotation, pricing, and settlement occur on a central server.

Suitable for platforms where metadata events may be transmitted.

### (2) On-Device Implementation

Cycle Hits and partial Hits History values are computed locally. Only aggregated values are transmitted. Supports privacy-preserving scoring in encrypted environments.

### (3) Federated Implementation

Multiple devices compute partial scores and merge them into a unified score. Supports cross-device consistency and privacy-preserving aggregation.

### (4) Hybrid Implementation

Combines:
on-device scoring,
cloud-based aggregation, and
partner-network synchronization.

All implementation modes remain fully consistent with the parent's hit-based scoring model, which requires no personal identifiers or message content.

### Example 1—Messaging-Based Commerce Funnel (Cycle Formation)

This example illustrates how a Cycle forms inside an encrypted messaging-based commerce funnel using only metadata-level events. Each event corresponds to a hit, and the sequence of hits forms a Cycle, exactly as disclosed in the 2003 parent.

### Step-by-Step Metadata Event Sequence

1. User views merchant profile
   Hit #1 (profile-view event)
2. User taps “Message Merchant”
   Hit #2 (chat-initiation event)
3. Merchant replies
   Hit #3 (merchant-response event)
4. User requests a quote
   Hit #4 (quote-request event)
5. Merchant sends a quote
   Hit #5 (quote-view event)
6. User clicks payment link
   Hit #6 (payment-link event)
7. User completes payment
   Hit #7 (payment-completion event)

### Cycle Termination

Upon payment completion, the system triggers cycle termination, exactly as in the parent:
merchant enters pending-unlist,
then unlisted,
then cooldown,
then relist.

### Hits History Update

The completed cycle contributes to Hits History, which:
increases ranking,
may change group assignment,
may adjust dynamic pricing,
may influence rotation position.

This example is a direct embodiment of the parent's repeated-hits→cycle→termination→relisting model, applied to messaging funnels.

### EXAMPLE 2—Fraud-Cycle Detection in Messaging Funnels

This example demonstrates how the system detects and suppresses fraud cycles using metadata-level signals, fully supported by the parent's popularity, traffic, and credit-score weighting disclosures.

### Abnormal Event Pattern

A merchant suddenly receives:
50 chat initiations in 30 seconds,
no meaningful message-exchange events,
no quote-view events,
no payment-link clicks,
identical timing patterns across multiple devices.

### Fraud-Cycle Indicators

The system detects:
abnormal cycle velocity,
synthetic traffic,
bot-like timing patterns,
lack of downstream funnel progression.

### Fraud-Cycle Suppression Actions

The system may:
reduce Cycle Hits,
decay Hits History,
demote the merchant to a lower group,
increase dynamic pricing,
place the merchant in cooldown,
block rotation,
trigger arbitration review.

These actions correspond directly to the parent's fraud-related score adjustments and credit-score penalties.

### EXAMPLE 3—Cross-Platform Rotation and Settlement

This example illustrates cross-platform rotation and cross-platform settlement, fully supported by the parent's partner-network bidding and exchange-group disclosures.

### Scenario

A merchant participates in a partner-network exchange group spanning:
WhatsApp,
Facebook Messenger,
Instagram Direct.

### Event Sequence

1. Merchant completes a cycle on WhatsApp.
2. Cycle termination triggers unlisting on WhatsApp.
3. Partner-network demand signals indicate that Messenger needs more merchants.
4. Merchant is rotated into Messenger.
5. Merchant receives a new lead on Messenger.
6. Payment is completed on Messenger.
7. Settlement is triggered across all platforms.
8. Hits History is updated globally.
9. Merchant is relisted across all platforms after cooldown.

### Cross-Platform Synchronization

group assignment is shared,
rotation position is shared,
fraud-cycle indicators are shared,
settlement outcomes are shared.

This is a direct continuation of the parent's partner-network coordination model.

### ALTERNATIVE EMBODIMENT 1—Non-Messaging Digital Funnels

In an alternative embodiment, the cycle-based scoring system may operate in non-messaging digital funnels, including:
web-based commerce flows,
mobile app interactions,
voice-assistant commerce flows,
QR-code-initiated purchase funnels,
kiosk-based ordering systems,
smart-device commerce interactions, and
augmented-reality or virtual-reality commerce environments.

In these embodiments, metadata-level events may include:
page views,
button taps,
voice-command acknowledgments,
sensor-triggered events,
device-proximity events,
QR-scan events,
AR/VR gesture events, and
payment-completion signals.

Each event corresponds to a hit, and sequences of hits form cycles, exactly as disclosed in the 2003 parent.

Cycle termination, Hits History accumulation, grouping, ranking, rotation, dynamic pricing, fraud-cycle suppression, settlement, and arbitration operate identically to the messaging-based embodiments.

This embodiment demonstrates that the parent's primitives apply to any digital funnel, not only messaging environments.

### ALTERNATIVE EMBODIMENT 2—Offline-to-Online Commerce

In another embodiment, the system may operate in offline-to-online commerce environments, where physical interactions generate metadata-level events that contribute to Cycle Hits and Hits History.

### Examples Include:

NFC tap events at physical stores,
Bluetooth beacon proximity events,
POS system interactions,
receipt-scan events,
loyalty-card swipes,
kiosk interactions, and
in-store QR-code scans.

These events may be treated as hits, and sequences of such events may form cycles, such as:
entering a store,
scanning a product,
receiving a digital coupon,
completing a purchase,
receiving a digital receipt.

Cycle termination may occur upon purchase completion or upon expiration of a time window.

Hits History may accumulate across both physical and digital interactions, enabling:
unified ranking,
unified grouping,
unified rotation,
unified dynamic pricing, and
unified fraud-cycle suppression.

This embodiment is fully supported by the parent's non-identifying, hit-based scoring model.

### ALTERNATIVE EMBODIMENT 3—Multi-Agent and Multi-Merchant Coordination

In another embodiment, the system may coordinate multiple merchants, multiple agents, or multiple automated systems within a shared scoring and rotation environment.

### Multi-Merchant Coordination

Multiple merchants may:
share group assignment,
share rotation position,
share waiting-list position,
share partner-network exchange groups,
compete for placement, or
collaborate in bundled offerings.

### Multi-Agent Coordination

Multiple AI-assisted merchant agents may:
coordinate responses,
share scoring data,
optimize cross-merchant funnels,
manage shared budgets,
negotiate settlement outcomes, or
detect cross-merchant fraud cycles.

### Multi-Platform Coordination

Merchants may operate across:
messaging platforms,
web platforms,
mobile apps,
voice assistants,
Ar/vr Environments,
partner networks.

All coordination mechanisms are fully supported by the parent's disclosures of:
partner-network bidding,
cross-engine rotation,
shared group assignment,
waiting-list exchange, and
dynamic pricing tied to accumulated cycles.

This embodiment ensures the system covers ecosystem-level coordination, not just single-merchant or single-platform behavior.

### ADVANTAGE 1—Privacy-Preserving Scoring Without Message Content

A first advantage of the invention is that it enables full-funnel scoring, grouping, ranking, rotation, pricing, settlement, and arbitration using only metadata-level events, without requiring access to message content or personal identifiers.

This is directly supported by the 2003 parent, which defines scoring exclusively in terms of:
hits,
cycles,
accumulated score values,
popularity weighting,
traffic weighting, and
credit-score weighting.

Because the parent's scoring model is inherently non-identifying, the present invention naturally extends to encrypted messaging environments where content is inaccessible.

This provides a decisive advantage over systems that require:
message inspection,
semantic analysis,
content classification, or
user-identity tracking.

The invention therefore supports privacy-preserving commerce in environments such as WhatsApp, iMessage, Signal, Telegram, and other encrypted platforms.

### ADVANTAGE 2—Unified Scoring Across Multiple Platforms and Funnels

A second advantage of the invention is that it enables unified scoring and rotation across multiple platforms, including:
messaging platforms,
web platforms,
mobile apps,
voice assistants,
AR/VR environments, and
offline-to-online commerce systems.

Because the parent discloses:
partner-network bidding,
cross-engine rotation,
shared group assignment,
waiting-list exchange, and
dynamic pricing tied to accumulated cycles,
   the present invention can unify scoring across any number of digital or physical funnels.

This provides a decisive advantage over systems that maintain:
siloed scoring,
platform-specific ranking,
isolated rotation behavior, or
inconsistent pricing across surfaces.

The invention ensures that merchants receive consistent treatment across all partner networks and all funnel types.

### ADVANTAGE 3—Fraud-Cycle Suppression and Credibility-Weighted Scoring

A third advantage of the invention is that it provides robust fraud-cycle detection and suppression, fully supported by the parent's disclosures of:
credit-score weighting,
popularity weighting,
traffic weighting,
negative score adjustments, and
penalty-group assignment.

The invention can detect:
bot-generated sequences,
synthetic traffic,
abnormal cycle velocity,
artificial payment-link clicks,
coordinated manipulation, and
cross-platform abuse patterns.

Fraud-cycle suppression may include:
score reduction,
Hits History decay,
group demotion,
rotation penalties,
dynamic pricing increases,
cooldown activation, and
arbitration review.

This provides a decisive advantage over systems that rely solely on:
content analysis,
manual review, or
heuristic filters.

The invention uses cycle-based evidence, which is more robust, more generalizable, and more resistant to manipulation.

### CONCLUSION—Continuation Lineage and Technical Coherence

The present invention provides a cycle-based scoring, grouping, ranking, rotation, pricing, settlement, arbitration, and partner-network coordination system that operates in encrypted, metadata-only messaging-commerce environments. Every mechanism described herein is a direct continuation of the primitives disclosed in the 2003 parent, including:
repeated hits,
cycle formation and cycle termination,
hits history accumulation,
group assignment,
rotation-group fairness,
dynamic pricing tied to accumulated cycles,
popularity and traffic weighting,
credit-score weighting,
fraud-related score adjustments,
waiting-list admission,
partner-network bidding and exchange groups, and
machine-state transitions.

The present invention does not introduce new scoring primitives. Instead, it applies the parent's primitives to:
encrypted messaging funnels,
metadata-only event streams,
cross-platform merchant distribution,
AI-assisted merchant agents,
federated and on-device scoring,
offline-to-online commerce, and
multi-agent, multi-merchant ecosystems.

This ensures full written-description support, full enablement, and full continuity with the 2003 parent.

### SCOPE OF THE INVENTION

Although specific embodiments have been described, the invention is not limited to:
messaging platforms,
specific event types,
specific scoring formulas,
specific rotation rules,
specific pricing models,
specific partner networks, or
specific arbitration workflows.

Any system that:

1. accumulates hits,
2. forms cycles,
3. terminates cycles,
4. maintains Hits History,
5. assigns groups,
6. performs rotation,
7. adjusts pricing,
8. detects fraud cycles,
9. manages settlement, or
10. coordinates across networks
   using non-identifying, hit-based scoring falls within the scope of the invention.

The invention therefore encompasses:
messaging-based commerce,
web-based commerce,
mobile-app commerce,
voice-assistant commerce,
AR/VR commerce,
offline-to-online commerce,
multi-agent systems, and
cross-platform ecosystems.

### CLAIM SUPPORT

The Detailed Description provides explicit support for all claims, including:
independent claims directed to cycle-based scoring in messaging funnels,
dependent claims directed to grouping, ranking, rotation, and pricing,
dependent claims directed to fraud-cycle suppression,
dependent claims directed to settlement and arbitration,
dependent claims directed to partner-network exchange groups,
dependent claims directed to privacy-preserving scoring,
dependent claims directed to AI-assisted merchant agents, and
dependent claims directed to distributed, federated, and hybrid architectures.

All embodiments are fully supported by the 2003 parent's disclosures of:
hits,
cycles,
accumulated score values,
popularity and traffic weighting,
credit-score weighting,
rotation-group fairness,
dynamic pricing,
partner-network coordination, and
machine-state transitions.

The invention therefore satisfies the requirements for:
written description,
enablement,
best mode, and
continuation priority.

1. A computer-implemented method, comprising:
receiving, from a messaging-based commerce funnel, a plurality of metadata-level interaction events associated with a merchant;
converting the interaction events into hits;
accumulating the hits into a cycle according to a recurrence condition;
detecting cycle termination when the accumulated hits satisfy a termination condition;
updating a Hits History for the merchant based on completed cycles;
assigning the merchant to a group based on the Hits History;
determining a rotation position for the merchant within the group; and
adjusting a pricing value for the merchant based on at least one of the cycle, the Hits History, the group, or the rotation position.

2. The method of claim 1, wherein assigning the merchant to the group comprises weighting the Hits History using at least one of popularity, traffic, or credit-score factors.

3. The method of claim 1, wherein determining the rotation position comprises applying a fairness-based rotation rule that periodically advances or demotes the merchant within the group.

4. The method of claim 1, further comprising transitioning the merchant through machine states including listed, pending-unlist, unlisted, cooldown, and relist based on cycle termination.

5. The method of claim 1, wherein adjusting the pricing value comprises increasing the pricing value as the merchant approaches cycle termination.

6. The method of claim 1, wherein adjusting the pricing value comprises modifying the pricing value based on long-term stability of the Hits History.

7. The method of claim 1, further comprising detecting a fraud cycle based on abnormal patterns in the interaction events.

8. The method of claim 7, further comprising applying a penalty comprising at least one of: reducing Cycle Hits, decaying Hits History, demoting the group, increasing the pricing value, or placing the merchant into cooldown.

9. The method of claim 1, further comprising placing the merchant into a waiting list when a group reaches capacity.

10. The method of claim 9, wherein waiting-list position is determined using at least one of Cycle Hits, Hits History, rotation position, or fraud-cycle indicators.

11. The method of claim 1, further comprising sharing at least one of Cycle Hits, Hits History, group assignment, rotation position, or pricing value with a partner-network exchange group.

12. The method of claim 11, further comprising rotating the merchant between platforms based on partner-network demand signals.

13. The method of claim 1, further comprising triggering settlement based on cycle termination or payment-completion events.

14. The method of claim 13, further comprising performing arbitration using cycle-verified evidence including Cycle Hits, Hits History, rotation transitions, or fraud-cycle indicators.

15. The method of claim 1, wherein the interaction events exclude message content and personal identifiers.

16. The method of claim 1, wherein converting the interaction events into hits is performed using on-device processing.

17. The method of claim 1, wherein the Hits History is computed using federated aggregation across multiple devices.

18. The method of claim 1, further comprising using an AI-assisted merchant agent to adjust at least one of budgets, thresholds, rotation behavior, or settlement actions based on the Hits History.

19. The method of claim 1, further comprising synchronizing machine-state transitions across multiple messaging platforms.

20. The method of claim 1, wherein the interaction events comprise at least one offline-to-online event selected from NFC taps, QR-code scans, POS interactions, or beacon-proximity events.
